(19) United States
(12) Patent Application Publication
(10) Pub. No.: US 2025/0183564 A1
(43) Pub. Date: Jun. 5, 2025

(54) TERMINAL-BLOCK ASSEMBLY

(71) Applicant: PHOENIX CONTACT GMBH & CO. KG, Blomberg (DE)

(72) Inventor: Heinz REIBKE, Bad Salzuflen (DE)

(21) Appl. No.: 18/842,410

(22) PCT Filed: Mar. 3, 2023
(86) PCT No.: PCT/EP2023/055417

§ 371 Date: Aug. 29, 2024

(30) Foreign Application Priority Data
Mar. 8, 2022 (LU) LU501612

(51) Int. Cl. H01R 9/24

(52) U.S. Cl. CPC H01R 9/2408

(57) ABSTRACT

A terminal-block assembly for connecting electrical conductors includes: a first terminal-block device having a first housing and a second terminal-block device having a second housing, the first housing and the second housing each having at least one conductor connection opening, a conductor connection opening of the at least one conductor connection opening in the first housing being offset with respect to a conductor connection opening of at least one conductor connection opening in the second housing relative to a base surface of the housings. The first housing and the second housing are arrangeable in a row and have, in a row direction of the first and second terminal-block devices, a same contour for arranging identical attachment parts on the first housing and on the second housing.

### CROSS-REFERENCE TO PRIOR APPLICATIONS

This application is a U.S. National Phase application under 35 U.S.C. § 371 of International Application No. PCT/EP2023/055417, filed on Mar. 3, 2023, and claims benefit to Luxembourg Patent Application No. LU 501612, filed on Mar. 8, 2022. The International Application was published in German on Sep. 14, 2023 as WO/2023/169947 under PCT Article 21(2).

### FIELD

The invention relates to a terminal-block assembly for connecting electrical conductors.

### BACKGROUND

Such a terminal-block assembly comprises a first terminal-block device having a first housing and a second terminal-block device having a second housing, wherein the first housing and the second housing each have at least one conductor connection opening, wherein the conductor connection opening in the first housing is offset with respect to the conductor connection opening in the second housing relative to a base surface of the housing.

Terminal-block assemblies have long been known in a wide variety of designs. They are assembled by the user on a mounting base, usually a mounting rail, to form functional blocks, for example a functional block for supplying energy to consumers. The individual terminal-block devices are therefore often also designed as distribution blocks and can be designed to have different numbers of poles and mounting types, depending on the intended application. For example, such a terminal-block assembly is described in EP 3743961 A1.

In the prior art, terminal-block devices of various designs, which for example often have different conductor connection directions such as horizontal or vertical conductor connection directions, and which are also often all intended for the same nominal cross section of the conductors, are often lined up in a row for a specific application, for example lined up in a row on a mounting rail.

However, these various terminal-block devices known from the prior art have the disadvantage that often housings of different designs and dimensions are used for the different terminal-block devices. Therefore, for each specific design, specific accessories have to be provided for fastening, marking, strain relief, etc.

### SUMMARY

In an embodiment, the present invention provides a terminal-block assembly for connecting electrical conductors, comprising: a first terminal-block device having a first housing and a second terminal-block device having a second housing, the first housing and the second housing each comprising at least one conductor connection opening, a conductor connection opening of the at least one conductor connection opening in the first housing being offset with respect to a conductor connection opening of at least one conductor connection opening in the second housing relative to a base surface of the housings, wherein the first housing and the second housing are arrangeable in a row and have, in a row direction of the first and second terminal-block devices, a same contour for arranging identical attachment parts on the first housing and on the second housing.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a view of a terminal-block assembly for connecting electrical conductors, comprising terminal-block devices arranged in a row according to one embodiment;

FIG. 2 is a view of a terminal-block assembly for connecting electrical conductors, comprising terminal-block devices shown separately from one another; and

FIG. 3A-3C are a top view and side views of the terminal-block assembly.

### DETAILED DESCRIPTION

In an embodiment, the present invention provides a terminal-block assembly having different types of terminal-block devices that can be used together, while at the same time reducing the use of specific attachment parts, often also referred to as accessory parts.

Accordingly, the first housing and the second housing are designed to be arrangeable in a row and have, in a row direction of the first and the second terminal-block device, the same contour for arranging identical attachment parts on the first housing and on the second housing.

An at least partially insulated, flexible or rigid, wire-shaped conductor that can be introduced by a stripped end into the effective region of a terminal-block device through a conductor connection opening in the housing of the terminal-block device can be referred to here as an electrical conductor. The stripped end region can be brought directly into the effective region of the terminal-block device, or can be provided with a wire end ferrule before the end region is brought into the effective region of the terminal-block device.

The conductor connection opening can be provided as a recess, in particular a circular recess, in the material of the housing and allows the electrical conductor, or the stripped end region of the electrical conductor, to come into contact with a contact element, such as a clamping leg, of the electrical conductor. Each housing has at least one conductor connection opening. However, in examples, the housings may also have more than just one conductor connection opening, and more than two terminal-block devices having corresponding housings may also be used in the terminal-block assembly.

The conductor connection opening in the first housing is offset with respect to the conductor connection opening in the second housing relative to a base surface of the housing. For example, the conductor connection opening of the first housing may extend vertically relative to the base surface and the conductor connection opening of the second housing may extend horizontally relative to the base surface. In examples, the conductor connection openings can also be diagonally offset with respect to one another.

The base surface can be referred to as the surface of the housing used to arrange the housing on a substrate, such as a mounting rail. Therefore, the base surface can also be referred to as the bottom surface or the bottom of the housing.

According to the invention, the first housing and the second housing are designed to be arrangeable in a row. Such an arrangement can be understood to mean that the housings can be arranged next to one another, for example surfaces of the housings can be connected to one another for this purpose. Furthermore, the housings have the same contour in a row direction of the terminal-block devices.

The row direction can be understood, for example, to mean a direction in which the terminal-block devices are arranged in a row along a length of a mounting rail or another substrate on which the terminal-block devices.

A contour can be understood here as a side view of the housings in the row direction or an outline of the side surfaces of the housings in the row direction.

The same contour in a row direction of the first and second terminal-block devices serves to arrange identical attachment parts on the first housing and on the second housing. An identical attachment part can be understood to mean an attachment part that can be arranged both on the first housing and on the second housing. Furthermore, the attachment part can have connecting means that are suitable both for attachment to the first housing and for attachment to the second housing. For this purpose, the first and the second housing can also have identical corresponding connecting means due to having the same contour. The use of different types of connecting means on the attachment parts or the use of different types of attachment parts can thereby be dispensed with.

Advantageously, such a design of the housings having the same contour allows for the use of a modular system having common attachment parts or accessory parts, which can be used both for the first terminal-block device and for the second terminal-block device. The use of additional attachment parts that must be specifically designed for use only with a specific housing type, can thus be dispensed with and costs can be saved.

In one example, the at least one conductor connection opening of the first housing extends vertically relative to the base surface and the at least one conductor connection opening of the second housing extends horizontally relative to the base surface.

Advantageously, terminal-block devices for horizontal and vertical conductor connection directions can thus be used together in one terminal-block assembly.

In one example, the first housing comprises a further conductor connection opening, wherein the further conductor connection opening extends vertically relative to the base surface and is arranged on an upper side of the first housing together with the conductor connection opening, and wherein the first terminal-block device is designed to electrically interconnect electrical conductors that can be arranged in the conductor connection opening and in the further conductor connection opening of the first housing.

The upper side of the housing can be understood here as a side of the housing that is opposite the base surface. The conductor connection openings can, for example, be arranged next to one another on the upper side at a distance from one another.

Advantageously, the first terminal-block device can thus be designed as a series terminal with vertical conductor connection directions.

In one example, the first housing has a plurality of conductor connection openings extending vertically relative to the base surface and collectively arranged on the upper side of the first housing, and the first terminal-block device is configured to electrically interconnect electrical conductors that can be arranged in the conductor connection openings of the first housing.

Advantageously, the first terminal-block device can also be designed as a terminal block and can electrically interconnect a plurality of connected electrical conductors. The conductor connection openings can, for example, be arranged in two rows extending in the row direction on the upper side of the housing.

In one example, the second housing has a further conductor connection opening, wherein the further conductor connection opening extends horizontally relative to the base surface and is arranged on a side of the second housing that is opposite the conductor connection opening, and wherein the second terminal-block device is designed to electrically interconnect electrical conductors that can be arranged in the conductor connection opening and in the further conductor connection opening of the second housing.

Advantageously, the second terminal-block device can thus also be designed as a series terminal with horizontal conductor connection directions.

In one example, the second housing has a plurality of conductor connection openings extending horizontally relative to the base surface and arranged on opposite surfaces of the second housing, and wherein the second terminal-block device is configured to electrically interconnect electrical conductors that can be arranged in the conductor connection openings of the second housing.

Advantageously, the first terminal-block device can also be designed as a terminal block and can interconnect a plurality of connected electrical conductors.

In one example, the housings each have corresponding connecting means, in particular corresponding tongue-and-groove connecting means, on side surfaces that are adjacent in the row direction.

Advantageously, the housings can be connected to one another by means of the connecting means, for example plugged together, in order to create a secure mechanical connection between the housings before the terminal-block device is fastened to the substrate or mounting rail.

In one example, the first and second terminal-block devices are each adapted to connect electrical conductors having the same nominal cross section.

This advantageously dispenses with the use of additional accessory parts and saves costs. In alternative examples, individual conductor connection openings can also be larger or smaller in order to also accommodate individual conductors having smaller or larger nominal cross sections.

In one example, the terminal-block assembly comprises at least one spring element and at least one actuating element, wherein the spring element is arranged in the first and/or second terminal-block device for locking and electrically contacting the electrical conductor in the conductor connection opening, and wherein the actuating element is adapted for transferring the spring element between a clamping position and a release position.

Advantageously, at least one electrical conductor can be introduced into a conductor connection opening according to the push-in principle and locked in the conductor connection opening and electrically contacted.

In one example, the first and/or second terminal-block device is designed as a screw terminal-block.

Advantageously, at least one of the terminal-block devices can also be designed as a screw terminal-block.

In one example, the base surface of the first and/or second housing is designed to be arrangeable on a mounting rail, in particular snapped thereon.

This advantageously allows for quick arrangement on a mounting rail.

In an alternative example, the terminal-block assembly comprises at least one adhesive arranged on the base surface of the first and/or second housing for sticking it to a substrate.

Advantageously, at least one terminal-block device can also be simply adhered to a substrate by means of an adhesive.

In one example, a contact leg extends out of the base surface of the first and/or second housing for electrically contacting at least one electrical conductor inserted into a conductor connection opening.

Advantageously, at least one terminal-block device can also be arranged on a printed circuit board.

In a further example, the terminal-block assembly comprises a bridge element that can be arranged between the first and the second terminal-block device in order to electrically interconnect electrical conductors introduced into the corresponding conductor connection openings of the first terminal-block device and the second terminal-block device.

Advantageously, by means of such a bridge element, all electrical conductors introduced into the conductor connection openings of the first and second terminal-block device can be electrically connected to one another.

In one example, the terminal-block assembly has at least one attachment part, in particular a fastening element, a marking element, or a strain relief element, wherein the attachment part can be arranged on the first housing and on the second housing.

For example, identical fastening elements, such as locking feet or fastening flanges, can be used on the first housing as well as on the second housing.

The housings can advantageously be used with a modular system of attachment parts or accessory parts. The attachment parts can be used for both the first terminal-block device and the second terminal-block device.

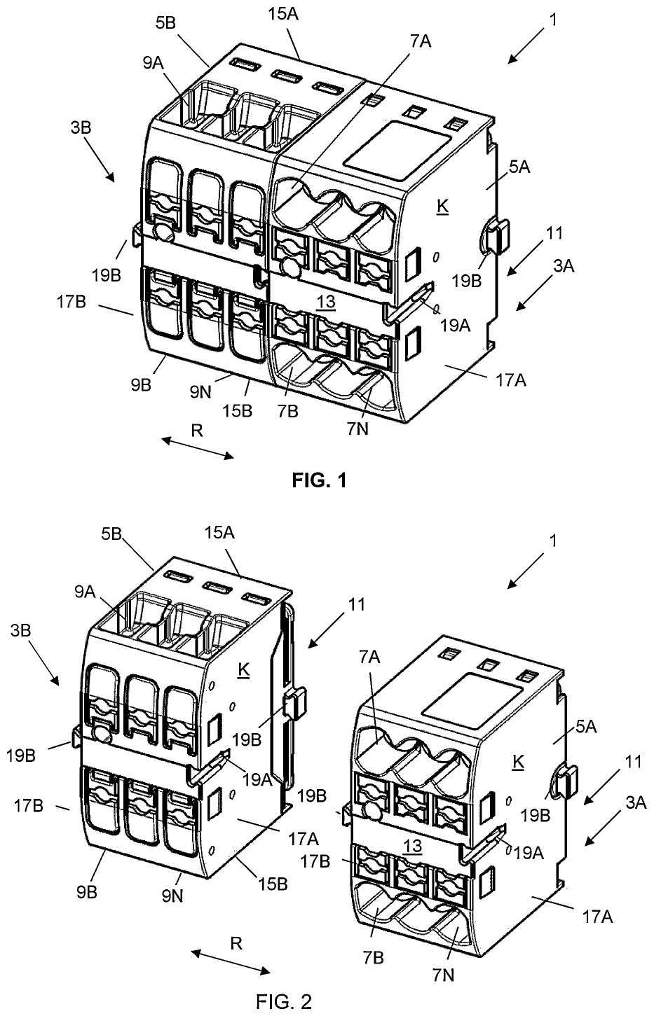

FIG. 1 is a view of a terminal-block assembly 1 comprising terminal-block devices 3A, 3B arranged in a row according to an embodiment. Both terminal-block devices 3A, 3B have housings 5A, 5B, which, in the embodiment shown, are designed as plastic injection-molded housings.

The first housing 5A of the first terminal-block device 3A shown has six conductor connection openings 7A-7N that extend vertically relative to the base surface 11 and are arranged on an upper side 13 of the first housing 5A. As shown, the conductor connection openings 7A-7N extend in two rows running in the row direction R on the upper side 13 of the first housing 5A. In embodiments, more or fewer conductor connection openings than the conductor connection openings 7A-7N shown may also be arranged on the upper side 13. The first terminal-block device 3A is designed as a terminal block and connects a plurality of connected electrical conductors to one another.

The second housing 5B of the second terminal-block device 3B shown also has six conductor connection openings 9A-9N that extend horizontally relative to the base surface 11 and are arranged on opposite surfaces 15A, 15B of the second housing 5B. In embodiments, more or fewer conductor connection openings than the conductor connection openings 9A-9N shown may also be arranged on opposite surfaces 15A, 15B of the second housing 5B. The second terminal-block device 3B is also designed as a terminal block and connects a plurality of connected electrical conductors to one another.

The row direction R is shown in FIG. 1 as a double-headed arrow, since the housings 5A, 5B used in the embodiment shown can be arranged next to one another in both directions of the arrow. For this purpose, the housings 5A, 5B each have corresponding connecting means 19A, 19B on side surfaces 17A, 17B that are adjacent in the row direction R, which connecting means are shown as corresponding tongue-and-groove connecting means, in order to connect the housings 5A, 5B to one another by the housings 5A, 5B being easily plugged together.

Furthermore, it is shown that the first housing 5A and the second housing 5B have the same contour K in the row direction R of the first and second terminal-block devices 3A, 3B.

In the embodiment shown, the first and second terminal-block devices 3A, 3B are each adapted to connect electrical conductors with the same nominal cross section. In alternative embodiments, individual conductor connection openings can also be larger or smaller in order to also be able to accommodate individual electrical conductors with smaller or larger nominal cross sections.

Furthermore, the terminal-block devices 3A, 3B shown are shown as push-in terminal blocks, for which purpose the terminal-block devices 3A, 3B shown each have a spring element in each of the conductor connection openings 7A-7N, 9A-9N shown, for locking and electrically contacting the electrical conductors in the conductor connection openings 7A-7N, 9A-9N. The spring elements can be moved between a clamping position and a release position by means of actuating elements. In alternative embodiments, the terminal-block devices can also be designed as screw terminal-blocks.

FIG. 2 is a view of the terminal-block assembly 1 previously shown in FIG. 1 for connecting electrical conductors, wherein in FIG. 2 the terminal-block devices 3A, 3B are shown separately from one another in order to be able to show the corresponding connecting means 19A, 19B more clearly. As shown, the housings 5A, 5B each have corresponding connecting means 19A, 19B on side surfaces 17A, 17B that are adjacent in the row direction R, which connecting means are shown as corresponding tongue-and-groove connecting means in order to connect the housings 5A, 5B to one another by simply plugging the housings 5A, 5B together.

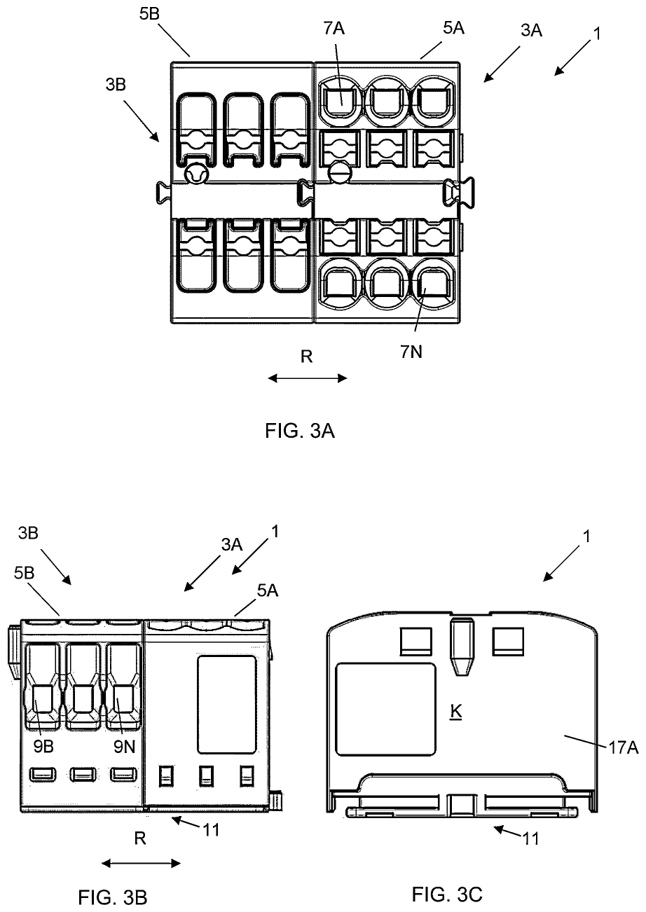

FIG. 3A is a plan view of the terminal-block assembly 1 already shown in FIG. 1. FIG. 3A shows that the conductor connection openings 7A-7N in the first housing 5A are offset from the conductor connection openings in the second housing 5B. In the plan view shown, the vertically extending conductor connection openings 7A-7N of the first terminal-block device 3A can be seen.

FIG. 3B is a side view of the terminal-block assembly 1 already shown in FIG. 1. In the side view shown, the conductor connection openings 9A-9N of the second terminal-block device 3B, which extend horizontally relative to the base surface 11, can be seen.

FIG. 3C shows another side view of the terminal-block assembly 1 previously shown in FIG. 1. In the side view shown, the housings are arranged one behind the other; the row direction extends in the viewing direction such that only the side surface 17A of a terminal-block device is visible and the same contours K of the terminal-block devices.

FIG. 3C also shows that the base surfaces 11 of the housings are designed to be arrangeable on a mounting rail. In alternative embodiments, the terminal-block assembly may comprise at least one adhesive that can be arranged on the base surface of the first and/or second housing for sticking the terminal-block assembly to a substrate.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Signs

1 terminal-block assembly
3A, 3B terminal-bock device
5A, 5B first housing, second housing
7A-7N, 9A-9N conductor connection opening
11 base surface
13 upper side
15A, 15B opposite surfaces
17A, 17B adjacent side surfaces
19A, 19B corresponding connecting means
R row direction
K contour

1. A terminal-block assembly for connecting electrical conductors, comprising:
a first terminal-block device having a first housing and a second terminal-block device having a second housing, the first housing and the second housing each comprising at least one conductor connection opening, a conductor connection opening of the at least one conductor connection opening in the first housing being offset with respect to a conductor connection opening of at least one conductor connection opening in the second housing relative to a base surface of the housings,
wherein
the first housing and the second housing are arrangeable in a row and have, in a row direction of the first and second terminal-block devices, the a same contour for arranging identical attachment parts on the first housing and on the second housing.

2. The terminal-block assembly of claim 1, wherein the at least one conductor connection opening of the first housing extends vertically relative to the base surface, and the at least one conductor connection opening of the second housing extends horizontally relative to the base surface.

3. The terminal-block assembly of claim 2, wherein the first housing has a further conductor connection opening,
wherein the further conductor connection opening extends vertically relative to the base surface and is arranged on an upper side of the first housing together with the conductor connection opening, and
wherein the first terminal-block device is electrically interconnectable to electrical conductors arrangeable in the conductor connection opening and in the further conductor connection opening of the first housing.

4. The terminal-block assembly of claim 3, wherein the first housing has a plurality of conductor connection openings extending vertically relative to the base surface, which plurality of conductor connection openings are collectively arranged on the upper side of the first housing, and
wherein the first terminal-block device is electrically interconnectable to electrical conductors arrangeable in the conductor connection openings of the first housing.

5. The terminal-block assembly of claim 2, wherein the second housing has a further conductor connection opening,
wherein the further conductor connection opening extends horizontally relative to the base surface and is arranged on a side of the second housing that is opposite the conductor connection opening, and
wherein the second terminal-block device is electrically interconnectable to electrical conductors arrangeable in the conductor connection opening and in the further conductor connection opening of the second housing.

6. The terminal-block assembly of claim 5, wherein the second housing has a plurality of conductor connection openings extending horizontally relative to the base surface and arranged on opposite surfaces of the second housing, and
wherein the second terminal-block device is electrically interconnectable to electrical conductors arrangeable in the conductor connection openings of the second housing.

7. The terminal-block assembly of claim 1, wherein the first and second housings each have corresponding connecting means comprising corresponding tongue-and-groove connecting means, on side surfaces that are adjacent in the row direction.

8. The terminal-block assembly of claim 1, wherein the first and second terminal-block devices are each configured to connect electrical conductors having a same nominal cross section.

9. The terminal-block assembly of claim 1, further comprising:
at least one spring element; and
at least one actuating element,
wherein the at least one spring element is arranged in the first and/or second terminal-block device and is configured to lock and electrically contact the electrical conductor in the conductor connection opening, and
wherein the at least one actuating element is configured to move the spring element between a clamping position and a release position.

10. The terminal-block assembly of claim 1, wherein the first and/or second terminal-block device comprise/comprises a screw terminal-block.

11. The terminal-block assembly of claim 1, wherein the base surface of the first housing and/or second housing is arrangeable on a mounting rail by being snapped on.

12. The terminal-block assembly of claim 1, further comprising:
an adhesive arranged on the base surface of the first housing and/or second housing, the adhesive being configured to stick to a substrate.

13. The terminal-block assembly of claim 1, further comprising:
a contact leg extending extends out of the base surface of the first housing and/or second housing, the contact leg being configured to electrically contact at least one electrical conductor arrangeable in a conductor connection opening.

14. The terminal-block assembly of claim 1, further comprising:
a bridge element arrangeable between the first terminal-block device and the second terminal-block device so as to electrically interconnect arrangeable electrical conductors in respective conductor connection openings of the first terminal-block device and the second terminal-block device.

15. The terminal-block assembly of claim 1, further comprising:
an attachment part comprising a fastening element, a marking element, or a strain relief element, the attachment part being arrangeable on the first housing and on the second housing.
